(19) United States
(12) Patent Application Publication
(10) Pub. No.: US 2011/0205625 A1
(43) Pub. Date: Aug. 25, 2011

(54) PASSIVE EYEWEAR STEREOSCOPIC VIEWING SYSTEM WITH SCANNING POLARIZATION

(75) Inventor: David Auld, San Jose, CA (US)

(73) Assignee: ZORAN CORPORATION, Sunnyvale, CA (US)

(21) Appl. No.: 12/900,738

(22) Filed: Oct. 8, 2010

Related U.S. Application Data
(60) Provisional application No. 61/306,857, filed on Feb. 22, 2010.

(51) Int. Cl. G02B 27/26

(52) U.S. Cl. 359/465

(57) ABSTRACT

A method of displaying images with an electronic display device having a plurality of sequentially updatable picture elements includes displaying an image with the picture elements by sequentially updating each of the plurality of picture elements, filtering light emanating from a first picture element with a first polarizing filter configured in a first polarization orientation and filtering light emanating from a second picture element with a second polarizing filter configured in a second polarization orientation that is different than the first polarization orientation. The method further includes detecting an update of a third picture element and switching the configuration of the second polarizing filter to the first polarization orientation in response to detecting the update of the third picture element.

### CROSS-REFERENCE TO RELATED APPLICATIONS

This application claims priority under 35 U.S.C. §119(e) to U.S. Provisional Application Ser. No. 61/306,857 entitled “PASSIVE EYEWEAR STEREOSCOPIC VIEWING SYSTEM WITH SCANNING POLARIZER,” filed Feb. 22, 2010, which is incorporated herein by reference in its entirety.

### BACKGROUND OF THE INVENTION

Embodiments of the present invention relate generally to stereoscopic imaging, and more specifically, to stereoscopic video displays for use with passive eyewear.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of an exemplary system in accordance with one embodiment of the present invention;

FIG. 2 is an exploded perspective view of an exemplary system in accordance with one embodiment of the present invention;

FIG. 3 is a timing diagram of an exemplary system in accordance with one embodiment of the present invention;

FIG. 4 is a timing diagram of an exemplary system in accordance with another embodiment of the present invention; and

FIG. 5 is a flow diagram of an exemplary method in accordance with one embodiment of the present invention.

### DETAILED DESCRIPTION OF THE INVENTION

Embodiments of this invention are not limited in their application to the details of construction and the arrangement of components set forth in the following description or illustrated in the drawings. Embodiments of the invention are capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

To enable stereoscopic (three-dimensional or “3D”) viewing of two-dimensional images, stereoscopic images are produced in pairs, with each image of the pair representing a scene presented at slightly different angles that correspond to the angles of vision of each human eye. For displaying stereoscopic images, particularly in movie theaters, various techniques involving simultaneous or synchronous projection of left and right field of view images have been developed. In one technique, two images, one for each field of view, are either superimposed upon each other or rapidly displayed in alternating succession. The viewer wears passive 3D eyewear, consisting of left and right circularly polarized lenses (e.g., RealD Format by RealD), frequency selective lenses (Dolby® 3D), or the like. The eyewear filters the projected images to the correct eye, giving the viewer the illusion of depth in the images. In theatrical projection systems, the field of view is updated synchronously with each frame of the movie.

For example, one stereoscopic theatrical projection technique uses alternate-frame sequencing where alternating frames of a movie or video are displayed in a left-right sequential manner. In the RealD theatrical 3D system, a switchable polarizer (also referred to herein as “steerable polarizer” or “SP”) is placed into the optical path of the movie projector. The SP is switched between left circular polarization and right circular polarization in synchronization with the alternating frames of the movie using a controllable LCD polarizer. The polarizer may be based on an Optically Compensated Bend Mode LCD Surface Mode Device with orthogonal rub direction, separated by a linear polarizer at 45 degrees to both rub directions (e.g., left and right). Such an arrangement operates as a single sheet retarder toggled through 90 degrees with no moving parts and is described, for example, in U.S. Pat. No. 4,792,850 to Lipton et al., which is hereby incorporated by reference in its entirety. A viewer wears passive eyewear having left and right circularly polarized lenses, which in conjunction with the SP steer the light of each frame to the corresponding eye (light going to the other eye is blocked by the polarized lens), enabling the viewer to perceive 3D effects. Passive eyewear is lightweight, inexpensive to manufacture, and may be made in many styles common to conventional eyewear, such as sunglasses, optical correction glasses, eye protection glasses, and contact lenses.

In theatrical applications, the movie is typically projected either from film stock or digitally (e.g., using DLP™ by Texas Instruments), and each frame of the movie is advanced nearly instantaneously. The SP is capable of switching at about 1000 Hz, which is fast relative to the frame rate of the projected movie. This enables the SP to switch polarization orientations between each frame advance, and therefore the viewer does not perceive any visual artifacts associated with mismatches between the polarization orientation of the SP and the projected 3D image.

Techniques have also been developed for viewing 3D movies at home. In a conventional 3D liquid crystal display (LCD) television, the viewer wears active eyewear having, for example, LCD pi-cell shutter lenses such as those described in Philip J. Bos et al., “The pi-Cell: A Fast Liquid-Crystal Optical-Switching Device,” Tektronix Corp., Mol. Cryst. Liq Cryst. 113 (1984), p. 329. The eyewear is coupled to the television system, and each lens is alternately switched between clear and opaque in synchronization with the frames of a movie that is displayed using the alternating field of view technique. Active eyewear, however, is heavy, expensive, and uncomfortable to wear.

With the advent of home theater systems, it is appreciated that consumers may enjoy viewing 3D movies using television equipment adapted for home use. It is further appreciated that a SP can be used in conjunction with, for example, a progressive or noninterlaced scan television for viewing 3D programs and movies. Such a television includes a display having a plurality of picture elements (also referred to herein as pixels) that are sequentially updated. A single, full-screen SP may be placed in front of the display area of the TV, and operate substantially as described above with respect to theatrical applications. However, in a progressive scan television, an update of the entire image (or field of view) occurs over a non-zero time interval (e.g., about 8 ms for a 120 Hz LCD TV) because each pixel of the display is updated sequentially, rather than simultaneously. For instance, at any given time during an update of the field of view (e.g., a scan of the display), one region of the TV screen may display the previous frame while the other, most recently updated region, displays the current frame. In an alternate-frame sequence, this causes crosstalk between the left and right eyes because there is insufficient time available between field updates for a single, full-screen SP to switch polarization orientations quickly enough to match the underlying image. This may produce visual artifacts that can be disconcerting to the viewer, and also diminishes the 3D effect.

In overview, embodiments of the present invention are generally directed to systems and methods for viewing stereoscopic images with passive eyewear. According to various embodiments of the invention, liquid crystal display (LCD) televisions, for example, are one popular type of television that may be so adapted. As used herein, “LCD” refers to the underlying screen of a display, for example, thin film transistor LCD (TFT-LCD). It should be understood, however, that various embodiments of the present disclosure may be implemented on other types of transmissive or emissive sequentially addressable displays, including, but not limited to, TFT-LCD, Organic Light Emitting Diode (OLED), devices incorporating certain microelectromechanical systems (MEMS), plasma display panels (PDP), and the like.

According to one aspect, a series of stereoscopic images are presented on an LCD display in an alternate-frame sequence. For example, the image series comprises alternating frames of left and right fields of view for generating an illusion of depth in conjunction with specialized eyewear. In one embodiment, the LCD display is covered by a secondary layer switchable light valve with a SP, or other similar device, such that the SP is inserted into the optical path of the display. One or more SPs may be used. In other embodiments, the SP may be other devices, including fast TFT-LCD shutters, MEMS cell based shutters, ferro-optical shutters, electrical field controlled opaque dies and inks, and the like. The SP is optically aligned with the underlying pixels of the display. According to one embodiment, the SP may be capable of left-handed (e.g., −45 degree) and right-handed (e.g., +45 degree) circular polarization, as well as intermediate degrees of polarization. The SP is compatible with passive eyewear having left and right circularly polarized lenses. In one example, when the polarizer is in a left-handed orientation, the image can be seen only through the left lens, and when the polarizer is in a right-handed orientation, the image can be seen only through the right lens. In another example, when the polarizer is in a left-handed orientation, the image can be seen only through the right lens, and vice versa. Passive eyewear is advantageous because it is lightweight, inexpensive, and comfortable to wear.

According to one embodiment, the screen of a progressive scan display (e.g., an LCD display) is covered by a SP that is segmented into a plurality of filter segments (e.g., horizontal segments) each covering a different region of the display. Each filter segment can be independently switched among a plurality of polarization orientations, including a left-handed polarization orientation, a right-handed polarization orientation, and an intermediate polarization orientation. The SP is optically aligned with the underlying pixels of the display, and each segment is at least one (1) pixel tall. Each segment may be, for example, the width of the display. As each pixel of the display is updated (e.g., from left to right and top to bottom, or other order), each filter segment of the SP is switched in sequence during or shortly after the update of the pixels underlying the segment. The SP steers the image displayed in the corresponding region of the display to the correct left or right eye as the image is updated. Accordingly, the viewer perceives each portion of the image with the correct eye throughout the scan, reducing the visual artifacts described above. In one embodiment, each segment is 16 pixels tall; however, it should be understood that each segment may be any height depending on the particular application. Alternatively, the segments may be any height and width.

In another embodiment, the polarization orientation of each segment may be switched (e.g., from left to right or right to left) sequentially from, for example, top to bottom (e.g., a “rolling” pattern) or in another sequence that follows or mimics the LCD update pattern. For example, when a pixel underlying the segment is updated, the polarization orientation of the corresponding segment of the SP is switched to match the handedness of the image displayed by the pixel. This enables the light emitted from the pixel to be steered, by the SP, to the correct eye of the viewer. In a fourth embodiment, each segment of the SP is switched left-to-right or right-to-left shortly after the underlying LCD pixels have been updated, which allows sufficient time for the LCD cell to adequately transition grey-grey and optimizes the 3D effect. In yet another embodiment, the segments of the SP are switched in a rolling sequence to follow the update pattern of the display. Various other sequences, timings, and arrangements of SP switching may be used according to the particular application.

In another embodiment, one or more adjacent SP segment(s) covering a region of the LCD display undergoing an update are momentarily “closed” by switching to a zero (or other intermediate) degree polarization orientation. For example, the SP segment(s) may be “closed” during the update of the corresponding region of the display. In the “closed” orientation, the corresponding SP causes both lenses of the passive eyewear to block a substantial portion of the light output from the LCD display, reducing visibility of the underlying LCD update. After the region of the display is updated, the corresponding SP segment(s) may switch to the left orientation or to the right orientation, as appropriate.

In another embodiment, each SP segment is switched directly from left to right or right to left as the underlying pixels are updated (or shortly thereafter); however, a portion of the backlight unit that illuminates the segment undergoing switching is momentarily dimmed (e.g., in a “rolling” pattern) to reduce visibility of the underlying LCD update. In yet another embodiment, each SP segment is momentarily closed, as described above, and the corresponding portion of the backlight unit is also dimmed to further obscure visibility of the underlying update.

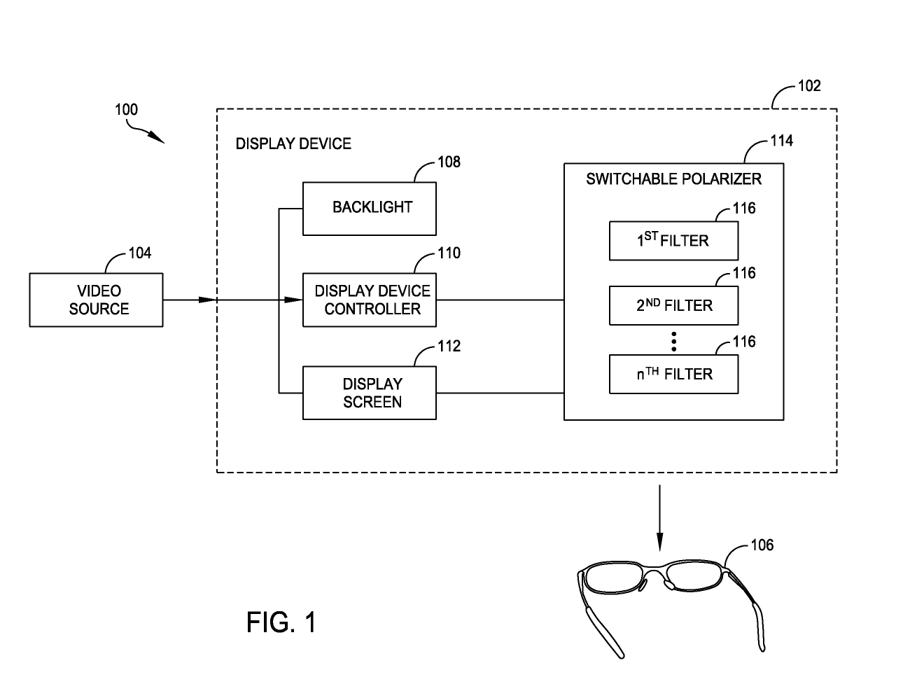

Referring to FIG. 1, a system 100 for viewing stereoscopic images in accordance with one embodiment includes a display device 102, a video source 104 that provides images to be displayed by the display device, and passive eyewear 106 to be worn by a viewer while viewing the display device. In some embodiments, the display device 102 is based at least in part on a progressive scan television, although the display device may also include additional or alternative components depending on the application. The display device 102 includes a backlight unit 108, a display device controller 110 coupled to backlight unit 108, a display screen 112 coupled to display device controller 110 and to backlight unit 108, and a switchable polarizing filter 114 coupled to display device controller 110 and to display screen 112. Display screen 112 includes a plurality of picture elements each adapted to display a portion of an image. Switchable polarizing filter 114 is optically aligned with display screen 112 such that light emanating from the picture elements is filtered by the switchable polarizing filter before being observed by the viewer using passive eyewear 106. Switchable polarizing filter 114 includes, in one embodiment, a plurality of non-overlapping and independently controllable filter segments 116, as will be described in greater detail below. Backlight unit 108 may be, for example, an edge-light unit or a backlight unit that illuminates at least a portion of the picture elements of display screen 112. In one embodiment, backlight unit 108 includes a plurality of independently controllable lighting segments, each segment being configured to illuminate a region of display screen 112. Control of each of the lighting segments may be performed by, for example, display device controller 110, or other backlight controller.

According to one embodiment, display device controller 110 receives a video signal from video source 104. The video signal may include 2D and/or 3D images, and frame synchronization information. Display device controller 110 uses the video signal to update each of the picture elements of display screen 112. Display device controller 110 may also use the synchronization information to synchronize the polarization orientation of each polarizing filter 116 with each of the video fields displayed by display screen 112 such that each frame (or portion of each frame) of the video, presented, for example, in an alternate-frame sequence, is steered by each polarizing filter to the correct eye of the viewer wearing passive eyewear 106.

According to one embodiment, display screen 112 is a sequentially addressable display screen, for example, a thin film transistor liquid crystal display (TFT LCD), an organic light emitting diode (OLED), other microelectromechanical systems (MEMS) devices, or a plasma display panel (PDP). It should be understood that the invention may also be implemented in other types of emissive, sequentially addressable displays. The display screen 112 includes a plurality of picture elements (also referred to herein as pixels), which may be divided in to multiple sub-pixels, for example, one for producing each of red, green, and blue light. The display screen 112 is updated sequentially at, for example, 120 Hz.

According to another embodiment, switchable polarizing filter 114 is a switchable polarizer (SP) that is placed in the optical path of display screen 112 and is optically aligned with the underlying picture elements of the display screen such that light emanating from the display screen is transmitted through the polarizing filter before reaching the viewer. Switchable polarizing filter 114 can be switched through a range of polarization orientations by, for example, display device controller 110 based on information provided by video source 104, such as the handedness of the image being displayed on all or part of display screen 112. The polarization orientations may include, but are not limited to, a left-handed orientation, a right-handed orientation, and any intermediate degree of orientation. The SP may, for example, be based on an Optically Compensated Bend Mode LCD Surface Mode Device with orthogonal rub direction, separated by a linear polarizer at 45 degrees to both rub directions (e.g., left and right), as described above with reference to theatrical projection systems. Such a filter operates as a single sheet retarder switched through 90 degrees (e.g., between −45 degrees and +45 degrees with respect to the rub directions of the linear polarizer) with no moving parts. Polarizing filter 114 may be switched by applying a voltage from, for example, display device controller 110, or other SP controller. Other degrees of polarization orientation are possible, including, for example, a zero degree “closed” orientation, by applying a partial voltage to achieve the intermediate polarization orientations. The SP may be capable of switching at about 1000 Hz, which is fast relative to the frame rate of the displayed image.

In one embodiment, polarizing filter 114 comprises a plurality of polarizing filter segments 116 each of which can be independently switched to one of a plurality of polarization orientations including, but not limited to, a left-handed orientation, a right-handed orientation, and any intermediate degree of orientation. Each filter segment 116 is optically aligned with a non-overlapping region of the display and may, for example, extend across the width of display screen 112. Each segment may be one or more pixels tall. The segments may be located adjacent to one another such that each picture element of the display is covered by at least one segment of the SP.

Backlight unit 108, according to one embodiment of system 100, comprises a plurality of independently controllable lighting segments that, when turned on, each illuminate at least a portion of the picture elements of display screen 112. Further, when a lighting segment is turned off, dimmed, blocked, shuttered, or extinguished, the image produced by the picture elements corresponding to the lighting segment may become dim or obscured from view. In one example, backlight unit 108 may be configured such that each of the lighting segments illuminates a region of the screen that substantially corresponds to a respective filter segment 116; that is, one lighting segment illuminates the same group of picture elements that are filtered by one of the filter segments 116. Accordingly, the filtering and/or visibility of any particular picture element may be controlled by either changing the polarization orientation of a corresponding filter segment 116, by illuminating or dimming the corresponding lighting segment, or both. It should be appreciated that in addition to a one-to-one correspondence between lighting segments and filter segments 116, there may be other ratios of correspondence, such as 2-to-1, 3-to-1, 1-to-2, and so on. Further, it should be appreciated that the lighting segments may be independently controlled, or controlled in gangs or groups of lighting segments, according to their particular application.

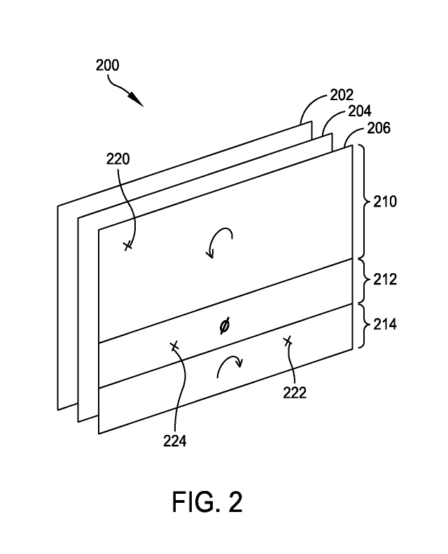

FIG. 2 is an exploded perspective view depicting a display device 200 for viewing stereoscopic images in accordance with one embodiment of the present invention. According to some embodiments, display device 200 includes an LCD display or other electronically modulated optical device that forms part of a television, computer, or other display device adapted to display images that, in conjunction with eyewear having polarized lenses, produce a stereoscopic effect for a viewer.

According to one embodiment, display device 200 includes a light source 202, a display screen 204, and a switchable polarizing filter 206. Light source 202 may include one or more florescent lamps, one or more light emitting diodes (LEDs), such as white phosphor based LEDs, red-green-blue (RGB) LEDs, organic LEDs (OLEDs), or other electronic light sources. In one embodiment, light source 202 is arranged in a backlit configuration for illuminating display screen 204 from behind with respect to a viewer of the light emanating from display device 200. In another embodiment, light source 202 may be configured to illuminate display screen 204 indirectly, such as from a side or edge of display screen 204.

In one embodiment, display screen 204 is a sequentially addressable display screen, for example, a thin film transistor liquid crystal display (TFT LCD), an organic light emitting diode (OLED), other microelectromechanical systems (MEMS) device, or a plasma display panel (PDP). The display screen 204 includes a plurality of sequentially addressable picture elements and may be controlled, for example, by a display device controller, such as display device controller 110 described above with reference to FIG. 1. Display device 200 may be configured such that light emanating from light source 202 propagates through the picture elements, outwards towards switchable polarizing filter 206, and onward towards the viewer.

In one embodiment, switchable polarizing filter 206 is optically aligned with the picture elements of display screen 204 such that light emanating from each of the picture elements passes through switchable polarizing filter 206, which filters the light into one or more of a plurality of polarization orientations. The light may be circularly polarized by switchable polarizing filter 206, for example, in a manner similar to that described above with reference to polarizing filter 114 of FIG. 1. The switching of switchable polarizing filter 206 may be controlled by, for example, a display device controller, such as display device controller 110 discussed above with reference to FIG. 1.

According to another embodiment, switchable polarizing filter 206 can switch between a left-handed orientation, a right-handed orientation, and a closed orientation. In one example, a viewer wearing eyewear having lenses adapted to transmit only left-handed polarized light to the left eye and right-handed polarized light to the right eye will observe a 3D effect because switchable polarizing filter 206 steers images to the correct eye; that is, for example, left-handed polarized light will be observed only by the left eye and right-handed polarized light will be observed only by the right eye. It should be appreciated that in other embodiments, switchable polarizing filter 206 may steer images to the opposite eye (e.g., using eyewear where the left lens is adapted to permit right-handed polarized light to reach the viewer's left eye, and vice versa). Light filtered in the closed orientation will be invisible or nearly invisible to the viewer, effectively obscuring the corresponding region of display screen 204.

According to one embodiment, display screen 204 is updated at a rate of 120 Hz, which is fast enough such that each scan of the entire screen is undetectable to the human eye under normal viewing conditions.

Still referring to FIG. 2, in one embodiment switchable polarizing filter 206 includes a plurality of segments, for example, a first segment 210, a second segment 212, and a third segment 214. It should be understood that switchable polarizing filter 206 may include any number of segments, wherein each segment is at least as tall as one picture element of display screen 204. Each segment 210, 212, 214 is optically aligned with a respective, non-overlapping group of the underlying picture elements, such that light emanating from any given picture element of the respective group is filtered by one segment of switchable polarizing filter 206. Each segment 210, 212, 214 is independently switchable among a plurality of polarization orientations, for example, a left-handed orientation, a right-handed orientation, and a closed orientation. For example, when wearing polarized eyewear that matches the polarization orientations of switchable polarizing filter 206, light transmitted by a segment switched to the left-handed orientation will be visible to the viewer's left eye; light transmitted by a segment switched to the right-handed orientation will be visible to the viewer's right eye; and light transmitted by a segment switched to the closed orientation will be invisible or nearly invisible to both of the viewer's eyes.

As discussed above, in one embodiment, switchable polarizing filter 206 includes three segments 210, 212, 214. FIG. 2 further illustrates, in one non-limiting example, a snapshot in time of the operation of display device 200 according to one embodiment. Shown are points on a plane of switchable polarizing filter 206 where light emanating from a first picture element 220, a second picture element 222, and a third picture element 224, all of display screen 204, passes outwardly through respective segments 210, 212, 214 of the filter. In the illustration, light transmitted by segment 210, including light emanating from first picture element 220, is circularly polarized in the left-handed orientation. Additionally, light transmitted by segment 214, including light emanating from second picture element 222, is circularly polarized in the right-handed orientation. Further, light transmitted by segment 212, including light emanating from third picture element 224, is circularly polarized in the closed orientation. Accordingly, the viewer wearing appropriate eyewear will perceive light from first picture element 220 with the left eye only, light from second picture element 222 with the right eye only, and light from third picture element 224 with neither eye (e.g., the light from third picture element 224 is substantially blocked by the polarized eyewear).

According to one embodiment, each picture element of the display screen 204 is sequentially updated from left to right across each row of picture elements, and from top to bottom, one row at a time. It should be appreciated that the present invention may be implemented in devices having alternative update patterns, such as right-to-left, bottom-to-top, and other sequences, and that the disclosed update patterns are intended to be non-limiting examples used in various embodiments. In one embodiment, as each picture element is updated, a respective segment of the polarizing filter that filters light emanating from the picture element is switched to a closed orientation. The passive eyewear blocks a substantial amount of the light being output by the picture element, reducing or eliminating the visibility of the update. After all of the picture elements corresponding to the respective segment of the polarizing filter have been updated, the filter may switch to a left-handed or right-handed polarization orientation as necessary to match the underlying portion of the frame, allowing the viewer to see that portion of the frame with the correct eye. This process may repeat in a rolling pattern that follows or mimics the update scan of the display screen.

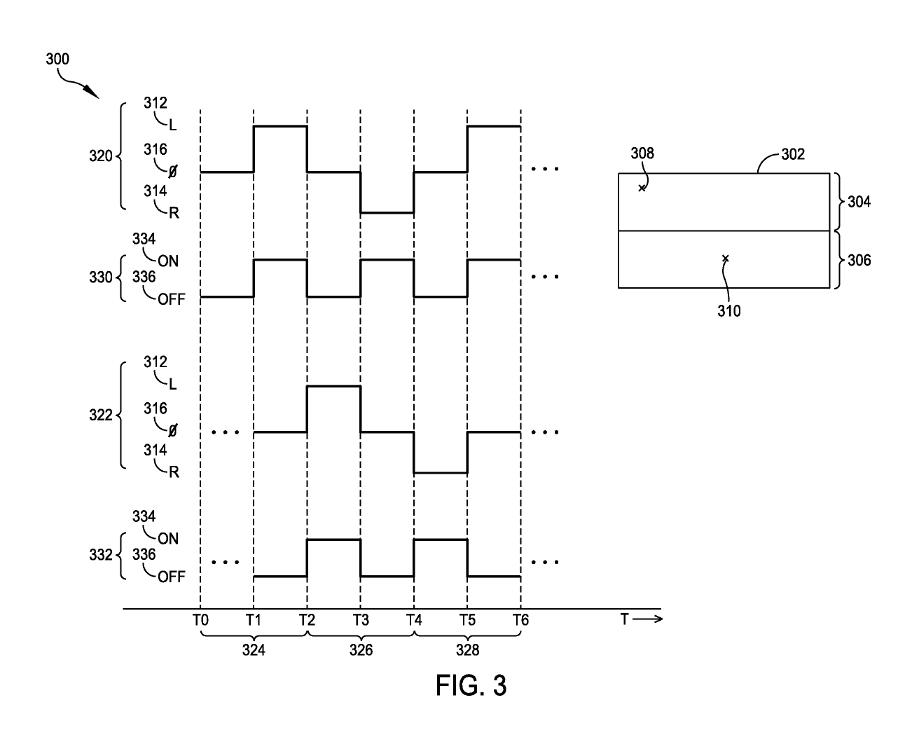

FIG. 3 is a timing diagram illustrating a sequence of polarization orientations 300 used by a visual display device 302 having a first polarizing filter 304 and a second polarizing filter 306 according to one embodiment. In one embodiment, first polarizing filter 304 and second polarizing filter 306 are independently controllable filter segments of a single polarizing filter, such as described above with respect to FIGS. 1 and 2. For example, the filter may include multiple SPs that are produced on a common glass substrate. In another embodiment, first polarizing filter 304 and second polarizing filter 306 may be distinct polarizing filters. Display device 302 has a plurality of picture elements including a first picture element 308 and a second picture element 310. In one example, display device 302 is configured to display alternating left and right frames of a stereoscopic movie, television program, or other video. As shown in FIG. 3, first picture element 308 is filtered by first polarizing filter 304, and second picture element 310 is filtered by second polarizing filter 306. Each of the polarization filters 304, 306 is independently switchable among a plurality of polarization orientations, including a left-handed orientation 312 (indicated as “L”), a right-handed orientation 314 (indicated as “R”), and a closed orientation 316 (indicated as “Ø”).

According to one embodiment, sequence 300 includes a sequence of polarization orientations for first polarizing filter 304, indicated at 320, and a sequence of polarization orientations for second polarizing filter 306, indicated at 322, both shown over a time interval T. At time T0, device 302 begins a first scan 324 wherein each of the picture elements are sequentially updated to display, for example, the first frame of a 3D video. First scan 324 may occur in a pattern from left to right and top to bottom, or in another pattern. Between time T0 and T1, each of the picture elements filtered by first polarizing filter 304, including first picture element 308, are updated. As shown in FIG. 3, during the update of first picture element 308, for example, first polarizing filter 304 is in closed orientation 316, which substantially blocks light emanating from first picture element 308 while it is updating from one frame to the next. This obscures from the viewer any visual artifacts caused by a transition of first picture element 308 from one image to another, or from one polarizing orientation to another, particularly during an alternate-frame sequence, as described above.

Between time T1 and T2, each of the picture elements filtered by second polarizing filter 306, including second picture element 310, are updated. During the update of second picture element 310, second polarizing filter 306 is in closed orientation 316. Simultaneously, or substantially simultaneously, with the updating of the picture elements filtered by second polarizing filter 306, first polarizing filter 304 may be switched to left-handed orientation 312, which steers light emanating from first picture element 308 to the left eye of the viewer. At time T2, first scan 324 is complete, and the first field of an image is fully displayed, although only the portion transmitted by first polarizing filter 304 is visible to the viewer because second polarizing filter 306 remains in closed orientation 316.

Subsequent to time T2, a second scan 326 begins. Second scan 326 may, for example, update each of the picture elements of display device 302 to display the next frame of the alternate-frame sequence. Between time T2 and T3, each of the picture elements filtered by first polarizing filter 304, including first picture element 308, are updated. During the update of first picture element 308, for example, first polarizing filter 304 is in closed orientation 316. Simultaneously, or substantially simultaneously, with the updating of the picture elements filtered by first polarizing filter 304, second polarizing filter 306 may be switched to left-handed orientation 312, enabling the viewer to see the remaining portion of first scan 324 with their left eye.

In sequence 300, the polarization orientations of each of the polarizing filters 304, 306 continue to switch in synchronization with updates of display device 302, for example, in a repeating closed-left-closed-right rolling pattern that follows the display scans. For example, between time T3 and T4, each of the picture elements filtered by second polarizing filter 306 are updated. A third scan 328 occurs between time T4 and T6, wherein first picture element 308 is updated between time T4 and T5, and second picture element 310 is updated between T5 and T6. Sequence 300 may continue indefinitely or until the 3D video ends.

According to another embodiment, sequence 300 includes a sequence of backlight illumination states 330, 332, including ON 334 and OFF 336, for a backlight unit including a plurality of independently controllable lighting segments, such as described above with respect to backlight unit 108 in FIG. 1. For example, sequence 330 illustrates the lighting state of one or more lighting segments corresponding to, e.g., first picture element 308 over time interval T, and sequence 332 illustrates the lighting state of one or more other lighting segments corresponding to second picture element 310. In this example, according to sequence 330, the illumination state of a backlight lighting segment corresponding to first picture element 308 is OFF 336, or dimmed, at substantially the same time that first polarizing filter 304 is in closed orientation 316. Further, the backlight segment corresponding to first picture element 308 is ON 334, or illuminated, at substantially the same time that first polarizing filter 304 is in an orientation other than closed 316, such as left-handed 312 or right-handed 314. In a similar manner, sequence 332 illustrates the illumination state of another lighting segment in relation to the polarization orientations of second polarizing filter 306. By dimming the lighting segment corresponding to a picture element while it is being updated, any visual artifacts associated with the update are invisible or nearly invisible to the viewer. It should be appreciated, however, that such control of the lighting segments may also be accomplished independently of the switching of polarizing filters 304, 306, or in a system having, for example, a single SP.

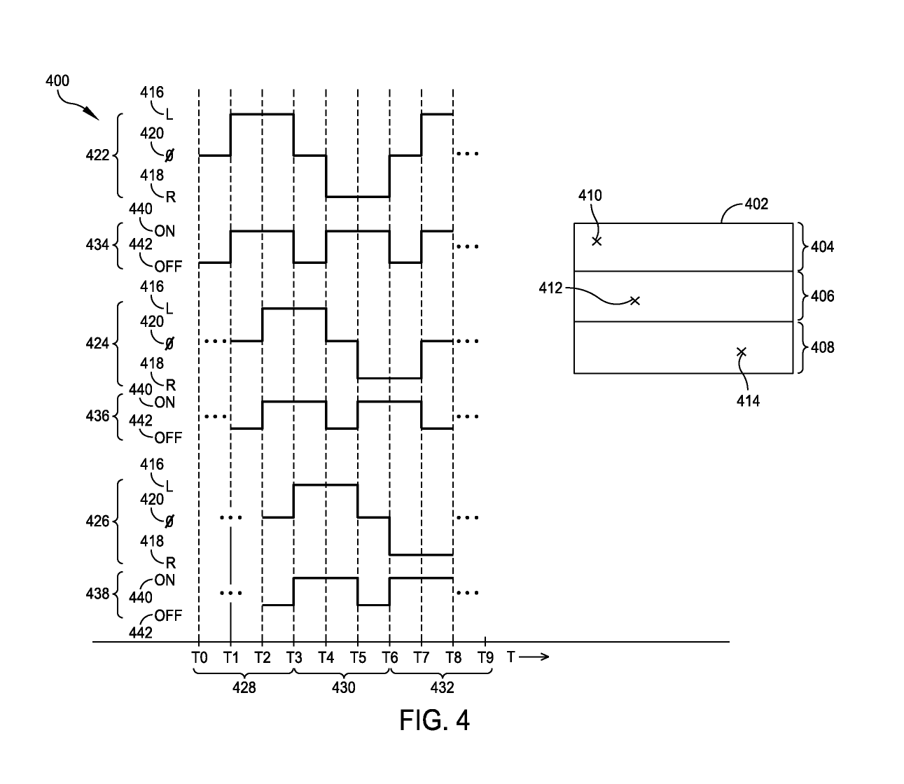

FIG. 4 is a timing diagram illustrating a sequence of polarization orientations 400 used by a visual display device 402 having a first polarizing filter 404, a second polarizing filter 406, and a third polarizing filter 408 according to one embodiment. In one example, display device 402 is configured to display alternating left and right frames of a stereoscopic movie, television program, or other video. Display device 402 has a plurality of picture elements including a first picture element 410, a second picture element 412, and a third picture element 414. As shown in FIG. 4, first picture element 410 is filtered by first polarizing filter 404, second picture element 412 is filtered by second polarizing filter 406, and third picture element 414 is filtered by third polarizing filter 408. As discussed above, each polarizing filter may be a separate filter, or they may be individual filter segments within a single filter. Each of the polarization filters 404, 406, 408 is independently switchable among a plurality of polarization orientations, including a left-handed orientation 416 (indicated as “L”), a right-handed orientation 418 (indicated as “R”), and a closed orientation 420 (indicated as “Ø”).

According to one embodiment, sequence 400 includes a sequence of polarization orientations for first polarizing filter 404, indicated at 422, a sequence of polarization orientations for second polarizing filter 406, indicated at 424, and a sequence of polarization orientations for third polarizing filter 408, indicated at 426, all shown over time interval T. At time T0, device 402 begins a first scan 428 wherein each of the picture elements of the display are sequentially updated to display, for example, the first frame of a 3D video. First scan 428 may occur in a pattern from left to right and top to bottom, or in another pattern. Between time T0 and T1, each of the picture elements filtered by first polarizing filter 404, including first picture element 410, are updated. As shown in FIG. 4, during the update of first picture element 410, for example, first polarizing filter 404 is in closed orientation 420, which substantially blocks light emanating from first picture element 410 while it is updating from one frame to the next. This obscures from the viewer any visual artifacts caused by a transition of first picture element 410 from one image to another, or from one polarization orientation to another, particularly during an alternate-frame sequence, as described above.

Between time T1 and T2, each of the picture elements filtered by second polarizing filter 406, including second picture element 412, are updated. During the update of second picture element 412, second polarizing filter 406 is in closed orientation 420. Simultaneously, or substantially simultaneously, first polarizing filter 404 may be switched to left-handed orientation 416, which steers light emanating from first picture element 410 to the left eye of the viewer.

Between time T2 and T3, each of the picture elements filtered by third polarizing filter 408, including third picture element 414, are updated. During the update of third picture element 414, third polarizing filter 408 is in closed orientation 420. Simultaneously, or substantially simultaneously, second polarizing filter 406 may be switched to left-handed orientation 416, which steers light emanating from second picture element 412 to the left eye of the viewer.

At time T3, first scan 428 is complete, and the first field of an image is fully displayed, although only the portions transmitted by first polarizing filter 404 and second polarizing filter 406 are visible to the viewer because third polarizing filter 408 remains in closed orientation 420.

Subsequent to time T3, a second scan 430 begins. Second scan 430 may, for example, update each of the picture elements of display device 402 to display the next frame of the alternate-frame sequence. Between time T3 and T4, each of the picture elements filtered by first polarizing filter 404, including first picture element 410, are updated. During the update of first picture element 410, for example, first polarizing filter 404 is in closed orientation 420. Simultaneously, or substantially simultaneously, third polarizing filter 408 may be switched to left-handed orientation 416, enabling the viewer to see a portion of first scan 428 as displayed by the picture elements filtered by third polarizing filter 408.

In sequence 400, the polarization orientations of each of the polarizing filters 404, 406, 408 continue to switch in synchronization with updates of display device 402, for example, in a repeating closed-left-closed-right pattern that follows the display scans. For example, between time T4 and T5 each of the picture elements filtered by second polarizing filter 406 are updated, and between time T5 and T6 each of the picture elements filtered by third polarizing filter 408 are updated. A third scan 432 occurs between time T6 and T9, wherein first picture element 410 is updated between time T6 and T7, second picture element 406 is updated between T7 and T8, and third picture element 414 is updated between time T8 and T9. Sequence 400 may continue indefinitely or until the 3D video ends.

According to another embodiment, sequence 400 includes a sequence of backlight illumination states 434, 436, 438, including ON 440 and OFF 442, for a backlight unit including a plurality of independently controllable lighting segments, such as described above with respect to backlight unit 108 in FIG. 1. For example, sequence 434 illustrates the lighting state of one or more lighting segments corresponding to, for example, first picture element 410 over time interval T, sequence 436 illustrates the lighting state of one or more other lighting segments corresponding to second picture element 412, and sequence 438 illustrates the lighting state of one or more additional lighting segments corresponding to third picture element 414. In this example, according to sequence 434, the illumination state of a backlight lighting segment corresponding to first picture element 410 is OFF 442, or dimmed, at substantially the same time that first polarizing filter 404 is in closed orientation 420. Further, the backlight segment corresponding to first picture element 410 is ON 440, or illuminated, at substantially the same time that first polarizing filter 404 is in an orientation other than closed 420, such as left-handed polarization orientation 416 or right-handed polarization orientation 418. In a similar manner, sequence 436 illustrates the illumination state of another lighting segment in relation to the polarization orientations of second polarizing filter 406, and sequence 438 illustrates the illumination state of yet another lighting segment in relation to the polarization orientations of third polarizing filter 408. By dimming the lighting segment corresponding to a picture element while it is being updated, any visual artifacts associated with the update are invisible or nearly invisible to the viewer. It should be appreciated, however, that such control of the lighting segments may also be accomplished independently of the switching of polarizing filters 404, 406, 408, or in a system having, for example, a single SP.

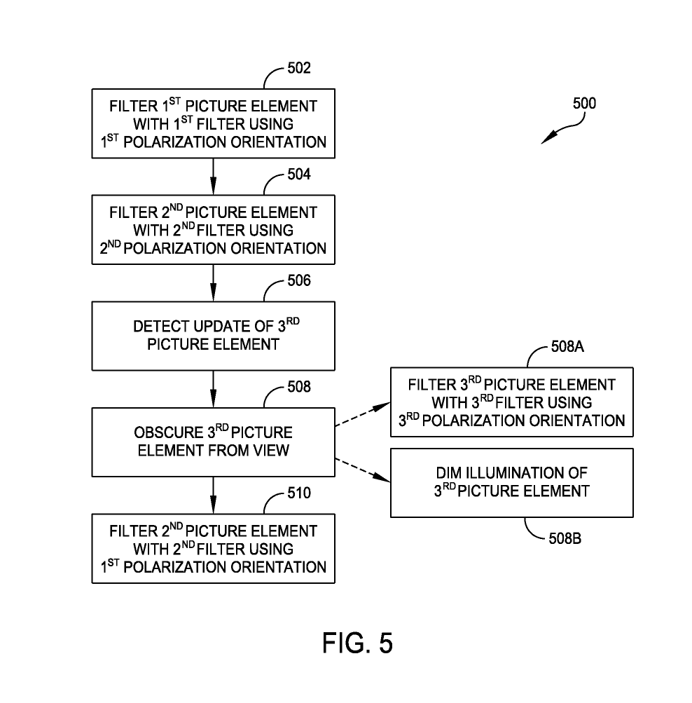

FIG. 5 is a flow chart illustrating a method of displaying a stereoscopic image 500 according to one embodiment. Method 500 may be implemented by a display device having, for example, a plurality of switchable polarizing filters including a first polarizing filter and a second polarizing filter. The first polarizing filter is optically aligned with a first picture element of the display device such that light emitted by the picture element is filtered by the first polarizing filter in one of a plurality of polarization orientations, such as a left-handed orientation, a right-handed orientation, or a closed orientation. Similarly, the second polarizing filter is optically aligned with a second picture element. The polarization orientation of each of the polarizing filters may be controlled by, for example, a display device controller that is coupled to a video source and each of the polarizing filters. The controller enables the polarization orientation of each polarizing filter to be synchronized with the image provided by the video source, so that the portion of the displayed frame underlying the polarizing filter is steered toward the correct eye of a viewer wearing passive eyewear. According to various embodiments, each polarizing filter may be one of a plurality of segments of a SP, or one of a plurality of separate, independently controlled SPs, or a combination of both.

Method 500 includes an act of filtering light emanating from the first picture element with the first polarizing filter using a first polarization orientation (ACT 502). For example, the first polarization orientation may be a left-handed orientation that matches the portion of the image displayed by the first picture element. In conjunction with eyewear having circularly polarized lenses, light transmitted in the left-handed orientation is perceived by, for example, only the left eye of a viewer wearing the eyewear. In another example, the first polarization orientation may be a right-handed orientation, and accordingly the light is perceived only by the right eye of the viewer. In one embodiment, the light emanating from the first picture element may represent an image from a current frame of the video after the first picture element has been updated, and prior to updating the first picture element with a subsequent frame of the video.

Method 500 further includes an act of filtering light emanating from the second picture element with the second polarizing filter using a second polarization orientation (ACT 504). For example, the second polarization may be a right-handed orientation that matches the portion of the image displayed by the second picture element. Accordingly, each of the first and second picture elements may be simultaneously, or substantially simultaneously, filtered using different polarization orientations, which enables the respective picture elements to be observed by different eyes of the viewer. This may occur, for example, in a sequentially updated display where the picture element being updated is located, sequentially, after the first picture element and before the second picture element such that the first picture element is displaying the current frame of the video and the second picture element is displaying the previous frame of the video (e.g., mid-scan).

Method 500 further includes an act of detecting an update of a third picture element of the display (ACT 506), for example, detecting when the image displayed by the third picture element is being updated from one frame to the next. For example, in a sequentially updated display, detection of the update of the third picture element may indicate that another region of the screen (e.g., a region containing either or both of the first and second picture elements) has recently completed updating. This indication may be used to switch the polarizing filter(s) corresponding to the first and/or second picture elements to a polarizing orientation corresponding to the respective portion of the recently updated image (e.g., left-handed or right-handed). The third picture element may be filtered by, for example, the first polarizing filter, or by any of a plurality of polarizing filters other than the second polarizing filter. For instance, the display may have two polarizing filters such that the first and third picture elements are filtered by the first polarizing filter, and the second picture element is filtered by the second polarizing filter. In another example, the display may have three or more polarizing filters such that the first picture element is filtered by the first polarizing filter, the second picture element is filtered by the second polarizing filter, and the third picture element is filtered by the third polarizing filter.

Method 500 further includes an act of obscuring the third picture element from view (ACT 508), e.g., for substantially the duration of the update of the third picture element. As described below, the third picture element may be obscured by switching the polarization filter corresponding to the third picture element, dimming the backlight, or both.

In one embodiment, ACT 508 optionally includes an act of filtering the third picture element of the display with the third polarizing filter using a third polarization orientation (ACT 508A). For example, the third polarizing filter may be switched to a closed orientation, as described above with respect to FIGS. 3 and 4, during the update of the third picture element to obscure, or substantially obscure, visual artifacts associated with the update from a viewer wearing polarized eyewear. In another example, the third polarizing filter may be switched to a polarization orientation corresponding to the respective portion of the image being displayed by any picture elements filtered by the third polarizing filter, including the third picture element (e.g., left-handed or right-handed).

In another embodiment, ACT 508 optionally includes an act of dimming illumination of the third picture element (ACT 508B). For example, an illumination unit, such as described above with reference to backlight unit 108 in FIG. 1, may include a plurality of lighting segments each configured to illuminate a portion of the picture elements of the display screen. Accordingly, the lighting segment that illuminates the third picture element may be extinguished, dimmed, shuttered, or blocked during the update of the third picture element to obscure, or substantially obscure, visual artifacts associated with the update from the viewer. The lighting segment may, for example, be illuminated again after the update of the third picture element is complete. If the update occurs sufficiently quickly, the dimming and re-illumination of the third picture element will be imperceptible, or substantially imperceptible, to the viewer.

Upon detecting the update of the third picture element, the polarization orientation of the second polarizing filter is switched to the first polarization orientation, such that the second picture element is filtered by the second polarizing filter in the first polarization orientation (ACT 510). Accordingly, both the first and second picture elements may be simultaneously, or substantially simultaneously, filtered using the same polarization orientation, which enables both picture elements to be observed by the same eye of the viewer. For example, each of the polarizing filters may switch in a left-right alternating sequence as the underlying picture elements are updated. In another example, each of the polarizing filters may switch in a left-closed-right-closed sequence, where the closed orientation is used momentarily to obscure the update from the viewer.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. For example, each segment of an SP may be manufactured as a separate unit, or as multiple SPs produced on a single glass substrate. Furthermore, the SP may be configured to transmit light in any number of polarization orientations that are compatible with eyewear for producing 3D effects. It should be appreciated that the video source may be projected in sequences other than an alternating-frame sequence, for example, with left and right fields of view projected simultaneously (or substantially simultaneously), or in a left-left-right-right sequence, or other combination of sequences. Furthermore, other techniques may be used to enhance the 3D effect of the displayed images, such as increasing the update rate of the display (e.g., 240 Hz or 480 Hz) and/or increasing the vertical blanking interval to enable the SP to switch polarization orientations between frame updates. Accordingly, the foregoing description and drawings are by way of example only.

What is claimed is:

1. A method of displaying images with an electronic display device having a plurality of sequentially updatable picture elements, the method comprising acts of:
displaying an image with the plurality of picture elements by sequentially updating each of the plurality of picture elements;
filtering light emanating from a first picture element of the plurality of picture elements with a first polarizing filter configured in a first polarization orientation;
filtering light emanating from a second picture element of the plurality of picture elements with a second polarizing filter configured in a second polarization orientation that is different than the first polarization orientation;
detecting an update of a third picture element of the plurality of picture elements; and
switching, responsive to the act of detecting, the configuration of the second polarizing filter to the first polarization orientation.

2. The method of claim 1, wherein the first polarization orientation corresponds to a polarization orientation of a portion of an image displayed by the first picture element.

3. The method of claim 2, wherein the polarization orientation of the portion of the image displayed by the first picture element corresponds to one of a left field of view and a right field of view.

4. The method of claim 3, wherein light filtered in the polarization orientation corresponding to the left field of view is obscured by a right lens of eyewear having polarized lenses, and wherein light filtered in the polarization orientation corresponding to the right field of view is obscured by a left lens of the eyewear.

5. The method of claim 4, wherein light filtered in the second polarization orientation is substantially obscured by the left lens of the eyewear and the right lens of the eyewear.

6. The method of claim 1, further comprising an act of obscuring the light emanating from the third picture element using the first polarizing filter during the update of the third picture element.

7. The method of claim 1, further comprising an act of dimming an amount of light provided to the third picture element during the update of the third picture element.

8. The method of claim 7, further comprising an act of increasing the amount of light provided to the third picture element responsive to completion of the update of the third picture element.

9. The method of claim 1, further comprising an act of filtering light emanating from the third picture element with a third polarizing filter configured in a third polarization orientation.

10. The method of claim 9, wherein the third polarization orientation is different than at least one of the first polarization orientation and the second polarization orientation.

11. An electronic visual display device, comprising:
a display screen having a plurality of non-overlapping regions and a plurality of sequentially updatable picture elements including a first picture element, a second picture element, and a third picture element;
a plurality of polarizing filter elements each optically aligned with a different non-overlapping region of the plurality of non-overlapping regions of the display screen and each independently switchable among a plurality of polarization orientations including a first polarization orientation and a second polarization orientation that is different than the first polarization orientation, the plurality of polarizing filter elements including a first filter element configured to filter light emanating from the first picture element in the first polarization orientation and a second filter element configured to filter light emanating from the second picture element in the second polarization orientation; and
a display device controller coupled to each of the plurality of polarizing filter elements and configured to switch each of the plurality of polarizing filter elements among the plurality of polarization orientations.

12. The device of claim 11, wherein each of the plurality of polarizing filter elements is a separate filter.

13. The device of claim 11, wherein each of the plurality of polarizing filter elements is a different segment of a single filter.

14. The device of claim 11, wherein the display device controller is further configured to switch the configuration of the second filter element to filter light emanating from the second picture element in the first polarization orientation in response to detecting an update of the third picture element.

15. The device of claim 11, wherein the first polarization orientation corresponds to a polarization orientation of a portion of an image displayed by the first picture element.

16. The device of claim 15, wherein the polarization orientation of the portion of the image displayed by the first picture element corresponds to one of a left field of view and a right field of view.

17. The device of claim 16, wherein light filtered in the second polarization orientation is substantially obscured by eyewear having polarized lenses.

18. The device of claim 11, further comprising a first illumination unit optically coupled to the display screen and configured to illuminate at least the first picture element, and a second illumination unit optically coupled to the display screen and configured to illuminate at least the second picture element.

19. The device of claim 18, wherein the display device controller is further coupled to the second illumination unit, and wherein the display device controller is further configured to dim an amount of light provided by the second illumination unit during a period of time in which the second filter element is configured to filter light emanating from the second picture element in the second polarization orientation.

20. The device of claim 19, wherein the display device controller is further configured to increase the amount of light provided by the second illumination unit subsequent to the period of time in which the second filter element is configured to filter light emanating from the second picture element in the second polarization orientation.

21. The device of claim 18, wherein each of the first illumination unit and the second illumination unit is a backlight illumination unit.

22. The device of claim 18, wherein each of the first illumination unit and the second illumination unit is an edge-light illumination unit.

23. The device of claim 11, further comprising a third filter element configured to filter light emanating from the third picture element in a third polarization orientation that is different than at least one of the first polarization orientation and the second polarization orientation.
